(19) United States
(12) Patent Application Publication
(10) Pub. No.: US 2006/0097467 A1
(43) Pub. Date: May 11, 2006

(54) Shopping cart with shopping bag dispenser

(75) Inventors: Gary B. Solomon, Dallas, TX (US); Mark B. Solomon, Brookline, MA (US)

Correspondence Address: SOLVISIONS TECHNOLOGIES INT'L INC., 82 ALBEMARLE ROAD, NORWOOD, MA, 02062, US

(73) Assignee: SOLVISIONS TECHNOLOGIES INT'L, INC.

(21) Appl. No.: 10/984,121

(22) Filed: Nov. 8, 2004

(51) Int. Cl. B62D 39/00

(52) U.S. Cl. 280/33.992

(57) ABSTRACT

A shopping cart that supports shopping bag dispenser(s) to enable shoppers to package goods as they shop. Shopping bag dispensers may be connected to fixtures that support goods to enable shoppers to obtain shopping bags while shopping.

### BACKGROUND

Retail stores in the twentieth century enabled consumers to purchase goods in an expedient fashion. No longer are the days that consumers have to shop at small, specialty locations, such as the butcher, baker, and shoemaker. As retail stores developed to become full service distributors of goods, so too did tools that (i) improved consumers' shopping experience and (ii) improved retail stores' ability to provide service to consumers. For example, the tools that improved consumers' shopping experience include shopping carts and grocery bags (e.g., plastic and paper bags). Tools that improved retail stores' ability to provide service to consumers include cash registers for adding-up the cost of the goods and inventory control, optical scanners to scan bar codes printed on packaging containing the goods, and self-checkout equipment complete with optical scanners and computers capable of instructing consumers how to perform self-checkout operations.

The twenty-first century promises to welcome continued improvement in retail store operations. A technology expected to be part of future advances is radio frequency identification (RFID) technology. RFID technology has been used for many years for automated tollbooths, pet tags, and other uses. For retail stores, RFID technology will be added in the form of an RFID tag to each individual product package and an RFID transceiver added to a checkout counter. The RFID tag identifies the product similar to the way a bar code identifies the product. However, rather than optically scanning the RFID tag, the RFID transceiver remotely determines the information contained in the RFID tag through use of radio frequencies.

RFID tags may be active and powered by a battery or may be passive, energized by the same radio frequencies used for communications with the RFID tag. In both cases, the RFID tag responsively communicates information stored in it to the transceiver. RFID tags may contain and communicate much more information than encoded in a bar code.

### SUMMARY

RFID technology promises to enable consumers to purchase goods expeditiously as a result of less handling of the goods at the point of purchase because of the transceiving of information associated with the goods. In other words, individual items in the shopping cart will not need to be removed, scanned, and bagged; a consumer will simply roll goods in the shopping cart past the RFID transceiver. The principles of the present invention advance the expedited processing by allowing the consumer, while shopping, to bag goods in a shopping cart adapted for use with RFID technology.

Accordingly, one embodiment of the principles of the present invention includes a shopping cart, which causes minimal or no interference with radio frequencies, that supports shopping bag dispenser(s) to enable shoppers to package goods as they shop. Additionally, the shopping carts may have dividers to form bins or have other mechanisms for holding the shopping bags. Alternatively, shopping bag dispensers may be located at various locations throughout a retail store to enable shoppers to obtain shopping bags for self-packing while shopping. By enabling the consumer to pack their items as they shop, the consumer may simply roll past an RFID communications station, purchase his or her goods, and roll the shopping cart to an automobile with the shopping bags full of goods for loading into the automobile.

In one embodiment, the principles of the present invention provide for a shopping cart that includes a frame having an upper portion and a lower portion. A plurality of wheels may be coupled to the lower portion of the frame to enable a shopper to roll the shopping cart. A basket may be coupled to the upper portion of the frame to enable a shopper to store goods in the shopping cart. A shopping bag dispenser may be coupled to the basket to enable the shopper to obtain shopping bags to bag goods while shopping.

In another embodiment, the principles of the present invention provide for a device including a fixture configured to support goods at a retail store. A shopping bag dispenser may be connected to the fixture to enable shoppers to obtain shopping bags while shopping.

### BRIEF DESCRIPTION OF DRAWINGS

A more complete understanding of the method and apparatus of the present invention may be obtained by reference to the following Detailed Description when taken in conjunction with the accompanying Drawings wherein:

FIG. 1 is an illustration of an exemplary shopping cart with one or more shopping bag dispensers;

FIGS. 2A-2C are illustrations of an exemplary shopping bag dispenser that may be adapted to an existing shopping cart;

FIG. 3 is an illustration of the shopping cart of FIG. 1 passing through an RFID station;

FIG. 4 is an illustration of a block diagram of an exemplary process for constructing a shopping cart with a shopping bag dispenser;

FIG. 5 is an illustration of exemplary shopping aisles of a retail store; and

FIG. 6 is an illustration of a flow diagram of an exemplary process for placing shopping bag dispensers in a retail store.

### DETAILED DESCRIPTION OF THE DRAWINGS

FIG. 1 is an illustration of an exemplary shopping cart 100 with one or more shopping bag dispensers 102a-102n (collectively 102). As shown, the shopping cart 100 may be in the form of a conventional shopping cart 104 configured with the shopping bag dispensers 102. The shopping bag dispensers 102 may be configured to hold shopping bags 104 in a closed form and enable a consumer to expand the shopping bags 104 as he or she shops. The shopping bags 104 may be paper or plastic.

In one embodiment, the shopping cart 100 includes a frame 106, basket 108, wheels 110, and handle 111. The frame 106 may be composed of non-metallic materials, such as PVC, to minimize or have no interference with radio frequencies. A basket 108, formed from plastic or other non-metallic material to have minimal interference with radio frequencies transmitted by an RFID system or RFID tags, may be connected to an upper portion of the frame 106. The wheels 110 may be connected to the bottom of the frame 106 to enable a shopper to roll the shopping cart 100. The shopping cart 100 may also include one or more bins (not shown) to enable the shopper to store the shopping bags 104 with goods in the bins to make it easier for the shopper to shop. Other mechanisms 112, such as hooks, may be mounted to the shopping cart 100 to suspend the shopping bags 104 from the hooks to allow the cart to transport more goods.

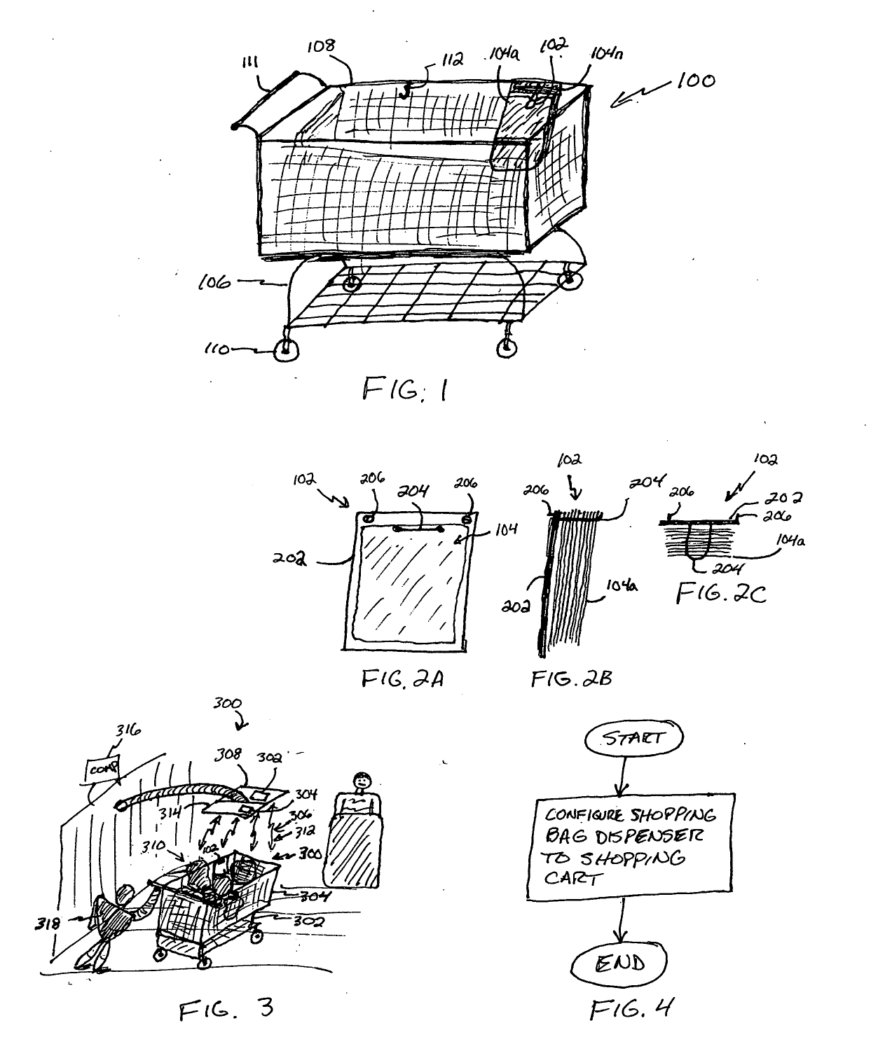

FIGS. 2A-2C are illustrations of the exemplary shopping bag dispenser 102 of FIG. 1 that may be adapted to an existing shopping cart. FIG. 2A is a front view of the shopping bag dispenser 102. In this embodiment, the shopping bag dispenser 102 is composed of a backboard 202 and one or more suspension members 204 or other holding mechanism to hold the shopping bags 104 in a closed state. Securing members 206 may be positioned to engage the backboard 202 to secure the shopping bag dispenser 102 to the shopping cart. The securing members 206 may be screws, bolts, clamps, or other non-permanent or otherwise permanent securing members. In a permanent securing embodiment, the shopping bag dispenser 102 may be welded or permanently secured to the shopping cart 100. Still yet, if the shopping bag dispenser 102 does not include a backboard 202, but is configured to include suspension members 204 or other dispensing mechanism(s), the securing members 206 may engage directly with the dispensing mechanism(s).

FIG. 2B is a side view of the shopping bag dispenser 102. As shown, the backboard 202 supports the suspension members 204 perpendicularly extending from the backboard 202. Other configurations are possible, including extending vertically (i.e., substantially in parallel to the backboard) or using a hinge to enable the suspension members 204 to be positioned out of the way from the basket of the shopping cart. As shown, the shopping bags 104 hang from the suspension members 204. The securing members 206 extend through the backboard 202 and are long enough to engage a portion of the shopping cart 100, such as a frame member or basket.

FIG. 2C is a top view of the shopping bag dispenser 102. The backboard 202 supports the suspension members 204, which is shown as a single member formed in a “U” shape. The securing members 206 extend through the backboard 202 to engage a portion of the shopping cart 100. A shopping bag 104a positioned at the front of the suspension members 204 may simply be opened and/or removed for use in packing goods by a shopper while shopping in a store. It should be understood that the shopping bag dispenser 102 as shown may be an aftermarket product to be sold separate from the shopping cart or original equipment of manufacture to be configured with the shopping cart before being sold to a store.

In operation, a consumer is able to simply pull on a portion of the shopping bag 104a, located in the front of the shopping bags 104 and configured in the closed state, to open the next shopping bag 104a to be filled with the goods. Alternatively, the shopping bag 104a may be removed from the shopping bag dispenser 102 and opened. It should be understood that any other mechanism(s) capable of supporting and dispensing shopping bags 104 in a closed state may be utilized in accordance with the principles of the present invention. For example, an elongated member, such as a dowel, may be utilized to support a roll of shopping bags that are perforated between shopping bags as understood in the art. As another example, a frame forming a pocket that extends along a sidewall or below the basket of a shopping cart may be utilized to hold shopping bags composed of paper.

FIG. 3 is an illustration of the shopping cart 100 of FIG. 1 having the shopping bag dispenser 102 passing through an RFID station 300. The RFID station 300 includes a transmitter 302 and a receiver 304 (collectively referred to as a transceiver). The transmitter 302 communicates a radio frequency signal 306 that is broadcast by a transmit antenna 308 to a local region. The radio frequency signal 306 may contact RFID tags (not shown) located on the goods 310 and, in response, produces a response radio frequency signal 312. The response radio frequency signal 312 may be sensed by a receive antenna 314, co-located or remotely located from the transmit antenna 308, and received by the receiver 304.

The receiver 304 may convert the response radio frequency signal 312 to a digital signal, in some embodiments, and communicate the digital signal to a computing system 316. Based on the digital signal, the computing system 316 may determine: the goods 310 that are in the shopping cart 100, the individual prices for the goods 310, and a total price of the goods 310. The shopper 318 may pay for the goods 310 using cash, credit card, or other form of currency supported by the RFID station 300, as understood in the art.

FIG. 4 is a flow diagram of an exemplary process 400 for constructing a shopping cart that dispenses shopping bags. The construction process 400 starts at step 402. At step 404, a shopping cart is configured with a shopping bag dispenser. The shopping bag dispenser may be configured (e.g., attached) to the shopping cart by using one or more fasteners. For example, the shopping bag dispenser may be screwed onto a base plate that contacts a sidewall of a basket of the shopping cart to maintain position and stability. Alternatively, the shopping bag dispenser may be hung over a top edge or grip onto the handle of the shopping cart. Still yet, the basket of the shopping cart may be manufactured with a shopping bag dispenser that is integral with the basket or other member of the shopping cart. Plastic, rubber, cloth, metal, or other material(s) may be used to connect the dispenser to the cart in embodiments the two parts are not permanently attached. Various techniques suitable for the different materials may be employed in the construction process 400. The construction process 400 ends at step 406.

While a shopping cart having one or more shopping bag dispensers is convenient for shoppers, a retail store may alternatively elect to add shopping bag dispensers to multiple locations about the retail store. Produce bag dispensers are generally provided for shoppers in the produce section. However, shopping bag dispensers are not because conventional retail stores individually scan or checkout each item, including the produce in produce bags.

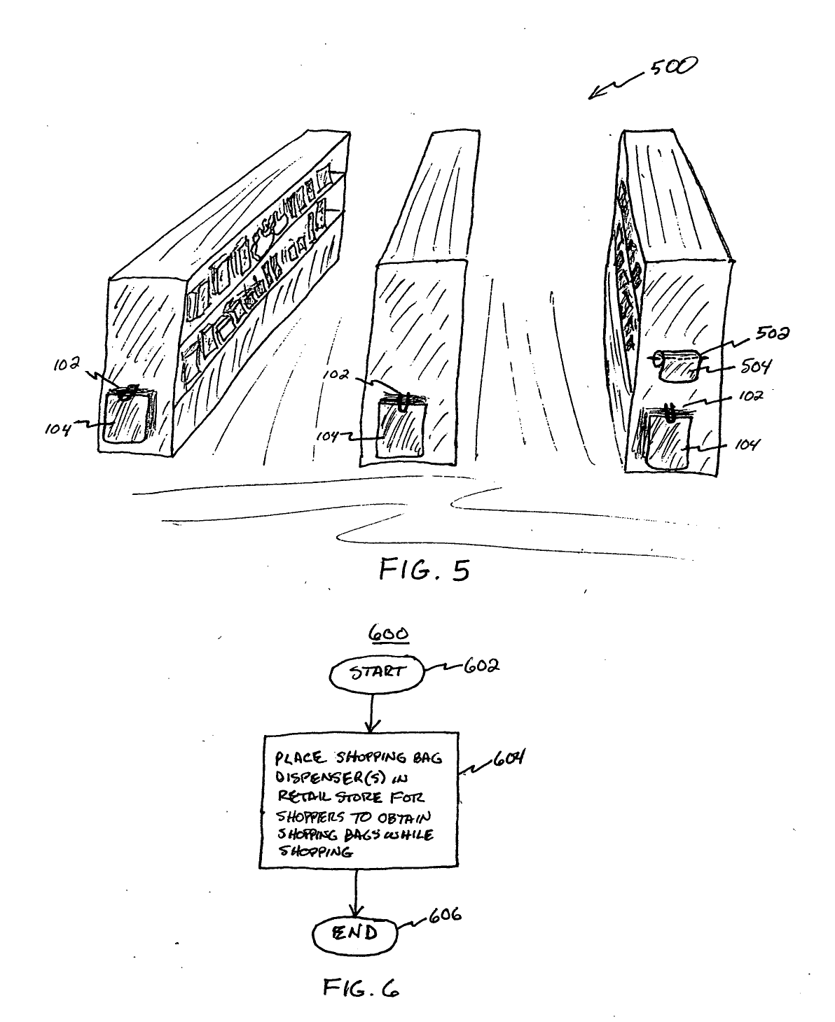

FIG. 5 is an illustration of exemplary shopping aisles 500 in a retail store. By adding shopping bag dispensers 102 at various locations in the retail store, shoppers may obtain and use shopping bags 104 as needed. For example, the shopping bag dispensers 102 may be located at each end of an aisle or multiple locations along an aisle 500. In one embodiment, the shopping bag dispensers may be located at or about the location of the shopping carts so that a shopper may obtain enough shopping bags for the visit. By placing shopping bag dispensers throughout the store, however, a shopper may tend to waste fewer shopping bags than if the shopping bags are located solely at the front of the store because the shopping bags are easier to obtain. The shopping bag dispensers 102 may be the same or similar to those of the shopping cart, but may have larger capacity for the number of shoppers accessing the same supply of the shopping bags 104. It should be understood that the shopping bag dispensers 102 may have virtually any configuration and dispense virtually any type of shopping bag according to the principles of the present invention. For example, a shopping bag dispenser 502 configured as a dowel may dispense shopping bags 504 in a roll having perforations between each shopping bag to enable a shopper to separate and dispense the shopping bags 504.

FIG. 6 is an illustration of a flow diagram of an exemplary process for placing shopping bag dispensers in a retail store. The process starts at step 602. At step 604, one or more shopping bag dispenser(s) is placed in a retail store for shoppers to obtain shopping bags while shopping. The placement of the shopping bag dispenser(s) may include attaching the shopping bag dispensers on fixtures or support structures (e.g., wall or pole) for supporting goods available for purchase by customers of the retail store. Alternatively, the shopping bag dispensers may be free standing (i.e., not attached to a fixture). In one embodiment, the shopping bag dispensers may be disposed at the end of aisles to make it convenient for a shopper to obtain shopping bags before too many goods have been collected and placed in the shopping cart without being placed in a shopping bag. Alternatively, the shopping bag dispensers may be located in the middle of an aisle or other locations to enable a shopper to obtain shopping bags while shopping. The process ends at step 606.

The previous description is of at least one embodiment for implementing the invention, and the scope of the invention should not necessarily be limited by this description. The scope of the present invention is instead defined by the following claims.

What is claimed is:

1. A shopping cart, comprising:
a frame having an upper portion and a lower portion;
a plurality of wheels coupled to the lower portion of said frame to enable a shopper to roll the shopping cart;
a basket coupled to the upper portion of said frame to enable a shopper to store goods in the shopping cart; and
a shopping bag dispenser coupled to the basket to enable the shopper to obtain a shopping bag to bag goods while shopping.

2. The shopping cart according to claim 1, wherein said shopping bag dispenser is configured to dispense shopping bags composed of plastic.

3. The shopping cart according to claim 1, wherein said shopping bag dispenser is configured to dispense shopping bags composed of paper.

4. The shopping cart according to claim 1, wherein said basket is non-metallic.

5. The shopping cart according to claim 1, wherein said shopping bag dispenser is non-metallic.

6. The shopping cart according to claim 1, further comprising at least one mechanism securing said shopping bag dispenser to said basket.

7. A device, comprising:
a shopping cart; and
a shopping bag dispenser connected to said shopping cart.

8. The device according to claim 7, wherein said shopping bag dispenser is configured to dispense plastic shopping bags.

9. The device according to claim 7, wherein said shopping bag dispenser is configured to dispense paper shopping bags.

10. The device according to claim 7, wherein said shopping cart includes a basket and said shopping bag dispenser is connected to the basket.

11. A method for manufacturing a shopping cart, said method comprising:
configuring a shopping cart including a basket; and
connecting a shopping bag dispenser to the shopping cart.

12. The method according to claim 11, wherein said connecting includes connecting the shopping bag dispenser to the basket of the shopping cart.

13. The method according to claim 11, wherein said connecting is performed after the shopping cart is completely configured.

14. The method according to claim 11, wherein said connecting is performed while configuring the shopping cart.

15. A device, comprising:
a shopping bag dispenser configured to dispense shopping bags and to connect to at least one member of a shopping cart.

16. The device according to claim 15, further including a connecting member utilized to connect the shopping bag dispenser to the at least one member of the shopping cart.

17. The device according to claim 15, wherein the shopping bag dispenser is configured to dispense plastic bags.

18. A device, comprising:
a fixture configured to support goods; and
a shopping bag dispenser connected to said fixture.

19. The device according to claim 18, wherein said fixture includes:
a base;
a vertical support member connected to said base;
at least one horizontal member connected to said vertical support member; and
at least one vertical member connected to the vertical support member;
wherein said shopping bag dispenser is connected to at least one of said base, said at least one horizontal member, and said at least one vertical member.

20. A method for enabling shoppers to obtain a shopping bag at a store while shopping, said method comprising:
placing at least one shopping bag dispenser in the retail store in locations to enable shoppers to obtain shopping bags while shopping.

21. The method according to claim 20, wherein said placing includes connecting a shopping bag dispenser to a fixture configured to support goods for sale at the store.

22. The method according to claim 20, wherein said placing includes connecting a shopping bag dispenser to a structure of the store.

23. The method according to claim 20, wherein said placing includes locating a shopping bag dispenser at the end of at least one aisle of the store.
